(19) United States
(12) Patent Application Publication
(10) Pub. No.: US 2026/0170917 A1
(43) Pub. Date: Jun. 18, 2026

(54) TRACKING POTENTIALLY SUSPICIOUS AWARDS DETERMINED BY A REMOTE GAME SERVER

(71) Applicant: IGT, Las Vegas, NV (US)

(72) Inventors: Kevin Higgins, Reno, NV (US); Jeffery Shepherd, Reno, NV (US)

(21) Appl. No.: 18/983,466

(22) Filed: Dec. 17, 2024

(51) Int. Cl. G07F 17/32

(52) U.S. Cl. CPC G07F 17/3241; G07F 17/3237

(57) ABSTRACT

Systems and methods that, responsive to an occurrence of a designated event determined by a remote game server operating with a personal gaming device determine a quantity of occurrences of the designated event associated with an identifier of the user relative to an expected quantity of occurrences of the designated event for the identifier of the user. Responsive to the determination being that the quantity of occurrences of the designated event associated with the identifier of the user exceeds the expected quantity of occurrences of the designated event for the identifier of the user, the systems and methods trigger a suspicious activity alert in association with the occurrence of the designated event.

### BACKGROUND

In various embodiments, responsive to a determination that a quantity of occurrences of a designated event associated with an identifier of a user and determined by a remote game server operating with a personal gaming device exceeds an expected quantity of occurrences of the designated event for the identifier of the user, the systems and methods of the present disclosure trigger a suspicious activity alert in association with the occurrence of the designated event.

Gaming machines may provide players awards in primary games. Gaming machines generally require the player to place a wager of credits to activate the primary game. The award of credits may be based on the player obtaining a winning symbol or symbol combination and on the amount of the wager.

### BRIEF DESCRIPTION OF THE SEVERAL VIEWS OF THE DRAWINGS

FIG. 1A is an example schematic configuration of a plurality of different components employed in association with the present disclosure operating to compare the actual results from one or more gaming devices over one or more gaming sessions to expected results from the gaming devices over such gaming sessions to determine if an investigation is warranted.

FIG. 1B is another example schematic configuration of a plurality of different components employed in association with the present disclosure operating to compare the actual results from one or more gaming devices over one or more gaming sessions to expected results from the gaming devices over such gaming sessions to determine if an investigation is warranted.

FIG. 2 is an example configuration of a plurality of different components employed in association with the present disclosure operating to analyze historical data associated with an identified user to determine if an occurrence of a handpay lockup event warrants a fraud investigation.

FIG. 3 is an example configuration of a plurality of different components employed in association with the present disclosure operating to analyze historical data associated with an anonymous user to determine if an occurrence of a handpay lockup event warrants an investigation.

FIG. 4 is an example configuration of a plurality of different components employed in association with the present disclosure operating to analyze historical data associated with an identifier of an online user to determine if an occurrence of a designated win warrants an investigation.

FIG. 5 is a schematic block diagram of one embodiment of an electronic configuration of an example electronic gaming machine of the present disclosure.

FIGS. 6A and 6B are perspective views of example alternative embodiments of an electronic gaming machine of the present disclosure.

FIG. 6C is a front view of an example personal gaming device of the present disclosure.

### DETAILED DESCRIPTION

In various embodiments, responsive to a determination that a quantity of occurrences of a designated event associated with an identifier of a user and determined by a remote game server operating with a personal gaming device exceeds an expected quantity of occurrences of the designated event for the identifier of the user, the systems and methods of the present disclosure trigger a suspicious activity alert in association with the occurrence of the designated event.

In certain embodiments, the system of the present disclosure tracks one or more events and/or activities occurring at one or more gaming devices over a period of time in association with a user. In different embodiments, the system tracks any event (and/or activity), any combination of events (and/or activities) or the lack of any event (or activity) that is potentially indicative of fraudulent behavior by a user of the gaming device with or without the involvement of gaming establishment personnel. In certain embodiments, the system tracks a total amount won by a specific user over one or more sessions at one or more gaming devices. For example, the system tracks total winnings over a period of time of a user accessing an online gaming establishment via a personal gaming device operating with a remote game server. In certain embodiments, the system additionally or alternative tracks instances of individual awards over a threshold amount being won by a specific user at one or more gaming devices. For example, the system tracks instances of progressive award triggering events occurring in association with a specific user. In these different embodiments, while various events and/or activities may occur (and be expected to occur) during a user's engagement with one or more gaming devices, in certain instances, the frequency of these events and/or activities occurring may be suggestive of potentially fraudulent activities by that user.

In certain embodiments, since unexpected patterns of certain events and/or activities have historically been affiliated with certain malicious behavior, the system of the present disclosure tracks occurrences of these events and/or activities. In these embodiments, the system examines the events and/or activities that occurred in association with a specific user at one or more gaming devices over a period of time relative to events and/or activities expected to occur in association with that specific user at such gaming devices over the period of time. The system then utilizes this comparison to potentially trigger a suspicious activity alert and/or undertake certain actions to combat any suspected fraud. Put differently, to determine certain suspicious conduct, the system tracks the frequency and/or pattern of certain events and/or activities and determines whether the tracked frequency and/or pattern differs, by a designated margin, with an expected frequency and/or pattern of such events and/or activities. In certain such embodiments in which the system tracks instances of awards over a threshold amount being won by a specific user at one or more gaming devices over one or more gaming sessions, the system determines if a fraudulent event potentially occurred (which warrants further investigation and/or action) based on a comparison of actual instances of awards over the threshold amount being won by the specific user at one or more gaming devices over one or more gaming sessions relative to a quantity of theoretical instances of awards over the threshold amount expected to be won by that specific user at the one or more gaming devices. In certain such embodiments in which the system tracks a total amount won by a specific user over one or more sessions at one or more gaming devices, the system determines if a fraudulent event potentially occurred (which warrants further investigation and/or action) based on a comparison of an actual total amount won by that specific user over one or more sessions at one or more gaming devices relative to a theoretical total amount expected to be won by that specific user over the one or more sessions at the one or more gaming devices.

It should be appreciated that the system of the present disclosure operates to track occurrences of events and/or activities and compare the tracked events and/or activities to prior occurrences of such events and/or activities for identified users (e.g., users associated with player tracking accounts) and/or anonymous users (e.g., uncarded users without any associated player tracking accounts). In certain such embodiments, the system tracks one or more events and/or activities of an identified user to potentially detect fraudulent behavior by that identified user. In these embodiments, since the system stores information associated with prior events and/or activities that occurred for the identified user, the system combines, in real time, the identified user's current tracked events and/or activities with these prior tracked events and/or activities and monitors, in real time, the resulting determined combination relative to an expectation of such events and/or activities. Suct monitoring and comparisons enable the system to detect whether or not the identified user is potentially engaging in nefarious behavior. In certain embodiments, the system additionally or alternatively tracks one or more events and/or activities of an anonymous user to potentially detect fraudulent behavior by that anonymous user. In these embodiments, since the system is unaware of prior events and/or activities associated with the anonymous user until a user identification event occurs (e.g., a user wins a relatively large award that necessitates gaming establishment personnel collecting the user's identification for tax reporting purposes), the system awaits for such a user identification event to occur and then combines tracked events and/or activities associated with a current session of that user with prior tracked events and/or activities associated with that same user from prior occurrences of user identification events. The system then compares the result of the combination to an expectation of such events and/or activities to detect whether or not that user is potentially engaging in nefarious behavior. As such, the system operates to determine potential fraudulent behavior of both users identified by the gaming establishment patron management system and users anonymous to the gaming establishment patron management system.

In certain embodiments, following the determination by the system that a fraudulent event potentially occurred, the system undertakes zero, one or more preventive actions to combat the security concern associated with the potential fraudulent event. That is, since certain tracked events and/or activities may or may not be associated with potential nefarious activities by users, responsive to the actual occurrences of such tracked events and/or activities falling outside a range of expected occurrences of such tracked events and/or activities, the system takes zero, one or more prohibit measures to minimize (or eliminate) these potential nefarious activities. In certain embodiments, based on one or more comparisons of tracked events and/or activities associated with a user relative to expected events and/or activities for that user, the system alerts gaming establishment personnel to intervene and investigate. For example, following a determination that a total amount won by a user over each of a series of gaming sessions exceeds a theoretical amount that should have been won for any of the gaming sessions, the system triggers a suspicious activity alert which instructs gaming establishment personnel to interact with the user and investigate. In certain embodiments, based on one or more comparisons of the tracked events and/or activities associated with a user relative to expected events and/or activities for that user, the system additionally or alternatively alters one or more workflow processes of gaming establishment personnel tasked with interacting with the user in association with such tracked events and/or activities. For example, following a determination that a quantity of progressive award triggering events exceeding a threshold quantity have occurred in association with the same user over a period of time or quantity of games played, the system modifies the payout of the progressive award to be tasked by senior gaming establishment staff. In certain embodiments, based on one or more comparisons of the tracked events and/or activities associated with a user relative to expected events and/or activities for that user, the system additionally or alternatively places one or more restrictions on future interactions the user may have with gaming devices until such tracked events and/or activities have been reviewed and cleared as legitimate. In certain embodiment, based on one or more comparisons of the tracked events and/or activities associated with a user relative to expected events and/or activities for that user, the system additionally or alternatively places one or more restrictions on any funds associated with such tracked events. These actions, individually and/or collectively contribute to a reduction in potentially fraudulent activities by users.

Accordingly, while gaming establishment regulators and gaming establishment equipment providers have introduced various security measures to make it relatively difficult for users to commit fraudulent acts, certain malicious users working alone or in collusion with gaming establishment personnel frequently attempt to overcome these security measures with an aim of fraudulently obtaining funds from a gaming establishment, such as a physical gaming establishment or an online gaming establishment. In view of certain actions undertaken by these malicious users, the system of the present disclosure tracks certain activities associated with potential fraudulent behavior, analyzes the frequency (and/or pattern) of such tracked activities relative to an expected frequency (and/or pattern) of such activities and, if warranted, takes zero, one or more preventive actions to combat these security concerns.

In various embodiments, the system includes (or is otherwise in communication with) various components or sub-systems operating together to determine if certain events that occur in association with one or more users (or the lack of certain events) are indicative of certain potentially fraudulent behaviors and if so, take zero, one or more preventative actions to minimize or deter such potential fraudulent behavior. In certain embodiments, the system includes (or is otherwise in communication with) a gaming device management system that operates with a fraud detection system to monitor for occurrences of different events associated with one or more users and/or one or more gaming devices that require further investigation and/or gaming establishment personnel intervention. For example, a gaming device management system monitors one or more EGMs for an occurrence of a handpay lockup event (e.g., when an award amount associated with a game outcome obtained from a play of a game that, when combined with the current amount of the credit meter, would cause the maximum limit of the credit meter to be exceeded, would exceed the jurisdictional handpay limit and/or would otherwise require gaming establishment personnel intervention, such as for tax reporting purposes, a handpay lockup event occurs and the gaming device is locked up awaiting an operator to process the award amount). In this example, upon the occurrence of such an event, the fraud detection system operates to determine whether or not further investigation is required (or alternatively suggested) prior to instructing gaming establishment personnel to proceed with the paying out of the award amount.

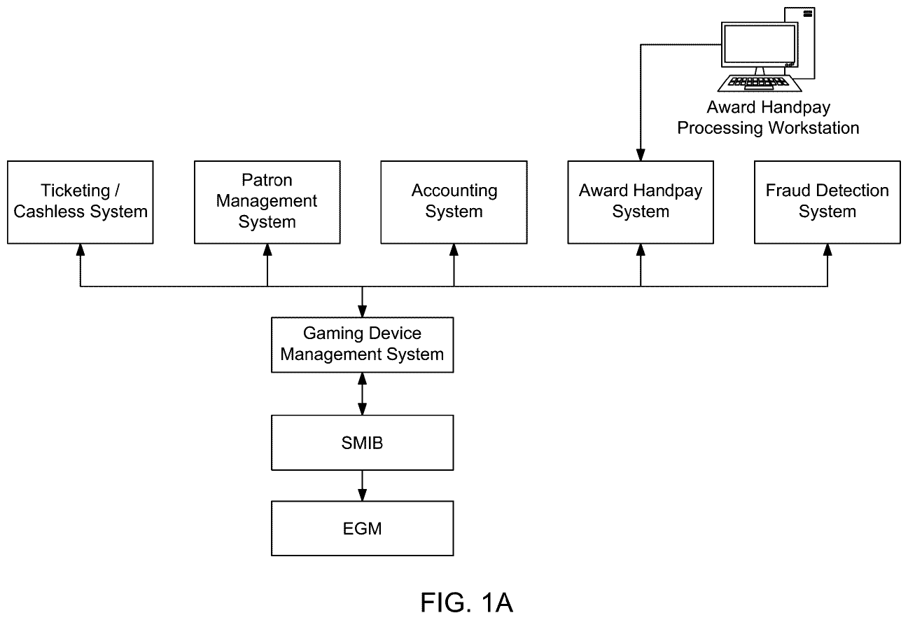

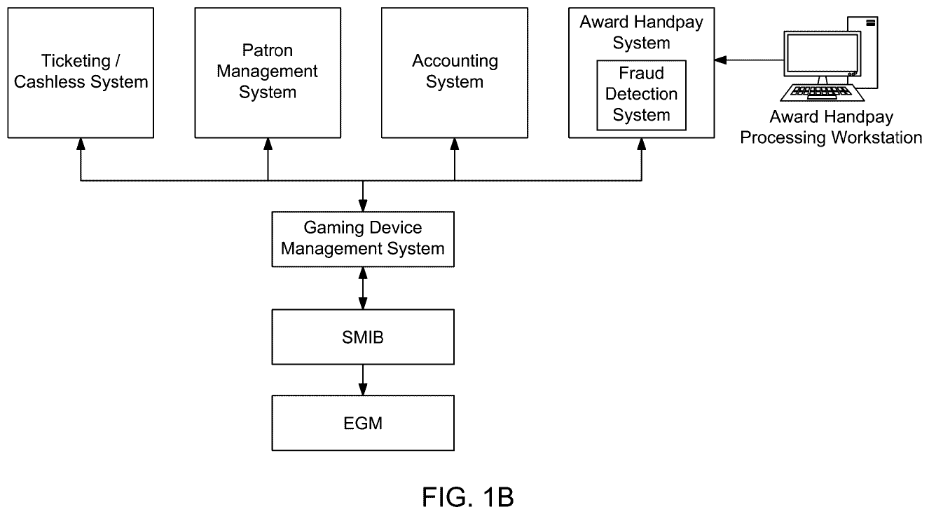

In certain embodiments, the gaming device management system is in communication with one or more gaming establishment patron management systems (e.g., patron management system of FIGS. 1A and 1B) that monitor activities at various points of contact associated with the gaming establishment and/or external from the gaming establishment. In certain embodiments, the monitored activity enables the gaming establishment patron management system to provide benefits, such as redeemable player tracking points, in association with such activities. In such embodiments, a user signs up for a loyalty account, such as a player tracking account of a player's club program, to earn loyalty points for their spend at the gaming establishment. A user then associates their play with their loyalty account by logging into the gaming establishment patron management system using an identification device. In certain embodiments, the identification device includes a physical instrument, such as a magnetic striped card, issued to the user and associated with a loyalty account of user. In these embodiments, the system enables the user to use such a physical instrument associated with a loyalty account to attempt to log into a gaming device and associate their play at the gaming device with their loyalty account. In various embodiments, the identification device includes a mobile device executing a gaming establishment mobile device application. In these embodiments, the system enables the user to use such a mobile device executing a mobile device application to log into a gaming device and associate their play at the gaming device with their loyalty account. In these different embodiments, following the association of the user's loyalty account with a gaming session occurring at a gaming device, the gaming establishment patron management system tracks events and/or activities occurring with identified users (including, but not limited to, tracking occurrences of events and/or activities subsequently employed to determine any patterns of play indicative of potential frauds being undertaken) and utilizes such tracking to determine a user's worth to the gaming establishment and the appropriate amount or level of marketing resources that should be allocated to that user given the value of the user to the gaming establishment.

In certain embodiments, as seen in FIGS. 1A and 1B, the gaming device management system is in communication with one or more components of the gaming establishment patron management system, such one or more slot machine interface boards (“SMIB”) associated with one or more gaming devices. In certain embodiments, the gaming devices and/or the components of the gaming establishment patron management system in communication with the gaming device management system comprise or are otherwise associated with one or more EGMs such as a slot machine, a video poker machine, a video lottery terminal, a terminal associated with an electronic table game, a terminal associated with a live table game, a video keno machine, a video bingo machine, a historical horse racing terminal and/or a sports betting terminal (offering sports betting opportunities and, in certain instances, wagering games). Such EGMs are operable to receive an amount of currency and/or a ticket voucher for an increase of a credit balance of the EGM, enable plays of wagering games of the EGM, and/or operate with a ticket voucher system to issue a ticket voucher for an amount corresponding to a cashed out credit balance of the EGM. In certain embodiments, such gaming devices additionally or alternative comprises a component of a gaming table which one or more table games are played at. In certain embodiments, such gaming devices additionally or alternatively comprises a personal gaming device on premises at a gaming establishment or remote from the gaming establishment (and operating with a remote game server that enables a user to access a website associated with a gaming establishment and/or execute a gaming establishment application to offer plays of wagering games (and in certain instances, offer sports betting opportunities). In these different embodiments, the gaming device management system includes one or more servers which interface with one or more gaming devices to receive data associated with the events and/or activities occurring at the gaming device. In certain embodiments, the data includes gaming device state data and the gaming device management system operates as part of gaming establishment floor management system. In certain embodiments, the data additionally or alternatively includes accounting data and the gaming device management system operates with (or otherwise as part of) an accounting system (e.g., accounting system of FIGS. 1A and 1B) that receives and processes accounting information regarding zero, one or more events that occur in association with zero, one or more gaming devices located on the gaming establishment floor.

In certain embodiments, the gaming device management system is in communication with one or more ticket voucher systems (e.g., ticketing/cashless system of FIGS. 1A and 1B). In these different embodiments, the ticket voucher system includes one or more servers which store, in one or more databases, ticket voucher identification information associated with each ticket voucher created by the ticket voucher system, such as identifying information, value information, and/or activity information. In certain embodiments, each ticket voucher includes or is otherwise associated with different identifying information which is identifiable to a holder of the ticket voucher, such as a ticket voucher validation number, and an amount of funds associated with the ticket voucher. In different embodiments, the ticket voucher database and/or the ticket voucher includes or is otherwise associated with various fields of ticket voucher identifying information including, but not limited to: (i) a primary key (i.e., an index for a record in a table); (ii) a ticket voucher validation number (i.e., the validation number associated with the issued ticket); (iii) a ticket state (e.g., a state of a ticket as being in an issued state, a redeemed state and/or a potentially fraudulent ticket voucher state); (iv) an issuance date/time (i.e., the date/time when the ticket voucher was issued); (v) a property address associated with the ticket voucher issuance; (vi) an amount of funds associated with the ticket voucher; (vii) any expiration date associated with the ticket voucher; (viii) a device identification associated with the issuance of the ticket voucher; (ix) an image of the ticket voucher (e.g., an image of a front of the ticket voucher and/or an image of a back of the ticket voucher); (x) any redemption date (i.e., the date the ticket voucher was redeemed at (if the ticket voucher is in the redeemed state)); (xi) redeemed at (i.e., the device where the ticket voucher was redeemed (if the ticket voucher is in the redeemed state)); (xii) a data signature (i.e., a signature of the data associated with the ticket voucher to prevent tampering by casino employees); (xiii) a machine identification (i.e., an asset or machine number of the device that printed the ticket voucher); and/or (xiv) any redemption limitations associated with the issued ticket voucher.

In addition to maintaining information associated with each ticket voucher, in certain embodiments wherein the ticket voucher takes the form of a paper ticket voucher, the ticket voucher system includes one or more ticket voucher system components, such as a ticket voucher printer configured to print paper ticket vouchers and/or a ticket voucher acceptor configured to receive paper ticket vouchers. For example, a ticket voucher printer is associated with a gaming establishment device that prints ticket vouchers. In certain other embodiments wherein a ticket voucher takes the form of a virtual ticket voucher, the ticket voucher system includes one or more interfaces operable to communicate, to a mobile device, data associated with a virtual ticket voucher. It should be appreciated that in different embodiments, the system utilizes a mobile device running a mobile device application, a kiosk, a gaming establishment device (e.g., an EGM), an externally controlled interface (e.g., a service window displayed by an EGM or by a display device associated with a SMIB), and/or a gaming establishment interface, such as a casino desk, to interface with one or more users to facilitate interactions with the ticket voucher system.

In certain embodiments, the gaming device management system is in communication with one or more cashless wagering systems (e.g., ticketing/cashless system of FIGS. 1A and 1B). Each cashless wagering system is associated with or otherwise maintain one or more cashless wagering accounts. In these embodiments, a user, such as a player of EGM, utilizes a mobile device application running on a mobile device and/or a physical instrument (e.g., a smart card or a user issued magnetic striped card which the user utilizes via inserting the card into a card reader associated with the EGM) to facilitate the electronic transfer of any funds between a cashless wagering account and a gaming device, such as the EGM and/or a component of a gaming table.

In certain embodiments, the gaming device management system is in communication with one or more gaming establishment personnel management systems (e.g., award handpay system of FIGS. 1A and 1B) that receives information from the gaming device management system regarding zero, one or more events that occur in association with zero, one or more gaming devices located on the gaming establishment floor. In such embodiments, upon receipt of certain information from the gaming device management system regarding one or more events that occur in association with one or more gaming devices located on the gaming establishment floor, the gaming establishment personnel management system creates one or more gaming establishment personnel tasks or directives and operates with one or more gaming establishment personnel devices (e.g., award handpay processing workstation of FIGS. 1A and 1B) to alert gaming establishment personnel of such tasks or directives. For example, if the gaming device management system determines that an occurrence of an award amount associated with a game outcome has caused an EGM to lock up awaiting gaming establishment personnel intervention, the gaming device management system alerts the gaming establishment personnel management system of the occurrence of such an event for processing by gaming establishment personnel.

In certain embodiments, as mentioned above, the system includes (or is otherwise in communication) with one or more fraud detection systems that receives data regarding one or more events occurring at one of more gaming devices and determines, based on such events relative to expected events, whether such events require further investigation and/or gaming establishment personnel intervention. For example, the fraud detection system monitors one or more EGMs for an occurrence of a handpay lockup event. In this example, upon the occurrence of such a handpay lockup event, the fraud detection system operates to determine whether further investigation is required (or alternatively suggested) prior to proceeding with the paying out the award that triggered the handpay lockup event. In certain embodiments, as seen in FIG. 1A, the gaming device management system is in communication with a distinct fraud detection system that tracks historic gaming activities by a user (such as a player identified via the gaming establishment patron management system), detects if the user's gaming activities qualify as abnormal and if so, flags that user and any historical, current and/or future gaming activities for further investigation. In other embodiments, as seen in FIG. 1B, the gaming device management system is in communication with a fraud detection system that is integrated with the gaming establishment personnel management system (i.e., integrated with the award handpay system) and operates to track historic gaming activities by a user (such as a player identified via the gaming establishment patron management system), detect if the user's gaming activities qualify as abnormal and if so, flag that user and any historical, current and/or future gaming activities for further investigation.

It should be appreciated that while, in certain illustrated embodiments, the gaming device management system is in communication with these different systems, in different embodiments, any system or sub-system of the present disclosure can be directly or indirectly in communication with each other. Additionally, while one or more of the systems in certain illustrated embodiments are independent of each other (e.g., the accounting system and the gaming establishment patron management system of FIGS. 1A and 1B) and two or more of these systems are combined (e.g., the ticket voucher system and the cashless wagering system of FIGS. 1A and 1B), in different embodiments, any system or sub-system of the present disclosure can be independent of any other system and/or combined with any other system as appropriate. Moreover, in different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with one or more of these systems.

In operation of certain embodiments in which the system potentially detects fraudulent behavior by an identified user (e.g., a carded player associated with a player tracking account), the system tracks one or more events and/or activities of the identified user and combines such currently tracked events and/or activities with prior tracked events and/or activities associated with the identified user. The system then compares the combination of actual events and/or activities that have occurred over a period of time relative to an expectation of events and/or activities that theoretically should have occurred over the period of time to detect whether or not that identified user is potentially engaging in nefarious behavior.

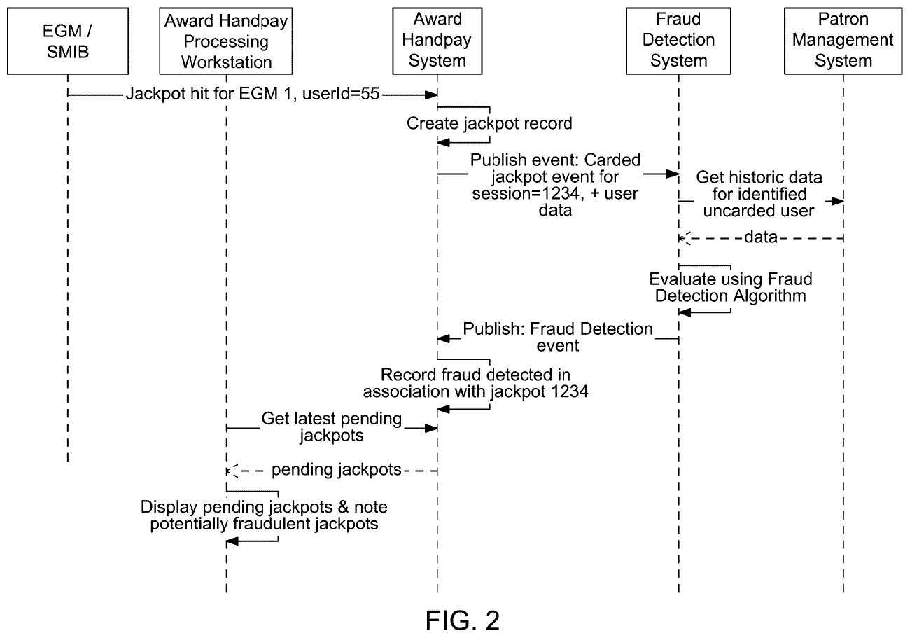

In certain embodiments, given the relatively infrequent occurrences of handpay lockup events, to determine if a suspicious activity alert should be triggered, the system tracks occurrences of such handpay lockup events over a current gaming session and/or one or more historic gaming sessions. In these embodiments, the system compares the actual quantity of occurrences of handpay lockup events for the identified user over the current gaming session and/or one or more historic gaming sessions to an expected quantity of occurrences of handpay lockup events for the current gaming session and/or the one or more historic gaming sessions. If the system determines that the actual quantity of occurrences of handpay lockup events for the identified user over the current gaming session and/or one or more historic gaming sessions exceeds, by a threshold amount, the expected quantity of occurrences of handpay lockup events for the current gaming session and/or the one or more historic gaming sessions, the system generates a suspicious activity alert. For example, as seen in FIG. 2 (which illustrates the described interactions between an EGM operating with a SMIB, a component of an award handpay system, a component of a fraud detection system and a component of a patron management system), following an EGM reporting a handpay lockup event (e.g., a pending jackpot) occurring in association with an identified user to the component of the award handpay system, the component of the award handpay system notifies the component of the fraud detection system of the occurrence of the handpay lockup event. The component of the fraud detection system then operates with the component of the patron management system to obtain historic handpay lockup event data associated with the identified user. The component of the fraud detection system evaluates, such as based on a fraud detection algorithm, the actual quantity of occurrences of the handpay lockup event for the identified user relative to an expected quantity of occurrences of the handpay lockup event and determines, based on this evaluation, whether to trigger a suspicious activity alert. If so, the component of the fraud detection system notifies the component of the award handpay system which takes one or more actions to trigger an investigation into the occurrence of the handpay lockup event.

As such, in certain embodiments, the system tracks gaming session activity associated with an identified user and determines if a combination of the tracked gaming session activity associated with the identified user and prior tracked gaming session activity associated with the identified user correspond to expected gaming session activity for the identified user. In these embodiments, responsive to the determination being that the combination of the tracked gaming session activity associated with the identified user and the prior tracked gaming session activity associated with the identified user do not correspond to the expected gaming session activity for the identified user, the system triggers a suspicious activity alert.

In certain embodiments, to determine if a suspicious activity alert should be triggered, the system tracks the actual win from an identified user over a current gaming session and/or one or more historic gaming sessions. For example, the system tracks an actual win over a period of time by combining any paytable wins from plays of game over the period of time, any non-paytable progressive award wins from plays of games over the period of time and any non-paytable wins independent of any plays of any games (e.g., mystery progressive award wins) over the period of time. In these embodiments, the system compares the actual win from the identified user over the current gaming session and/or one or more historic gaming sessions to an expected win (i.e., a theoretical win) for the current gaming session and/or the one or more historic gaming sessions. Continuing with the above example, the system calculates an expected win by combining expected paytable wins from plays of game over the period of time (i.e., multiplying a user's wagers placed on a game by the payback percentage of the applicable paytable for that game), expected non-paytable progressive award wins from plays of games over the period of time and expected non-paytable wins independent of any plays of any games over the period of time. In these embodiments, if the system determines that the identified user has engaged in a minimum amount of wagering activity (e.g., placed a certain minimum amount of wagers which operates to filter out short-term lucky users), and if the system further determines that the actual win is larger than expected win by at least threshold amount (e.g., actual wins exceed expected wins by 50%), the system generates a suspicious activity alert.

In certain embodiments, the threshold amount above expected that triggers a suspicious activity alert is a static amount based on historic observations of activity at a gaming establishment. In certain embodiments, the threshold amount above expected that triggers a suspicious activity alert is a dynamic amount that changes over time based on an analysis of historical user activity. In certain such embodiments, the system employs generative artificial intelligence, such as a trained language learning model, to modify the employed threshold amount above expected based on prior suspicious activity alerts and the resulting investigations. For example, the system employs historic user activity and determines a new threshold amount that excludes 99% of the samples over a training data set.

In certain embodiments, the threshold amount above expected that triggers a suspicious activity alert is the same for each identified user. In certain embodiments, the threshold amount above expected that triggers a suspicious activity alert is different for different identified users. For example, the system employs a threshold value of 110% (i.e., actual wins 10% above expected wins over a period of time triggers a suspicious activity alert) for a relatively low-lifetime value identified user and a threshold value of 140% for a relatively high-lifetime value identified user to avoid disruptions to the relatively high-lifetime value identified user's visit to a gaming establishment. In these embodiments, different attributes associated with a user, such as, but not limited to, status or ranking (e.g., as determined via the gaming establishment patron management system), wagering history, non-wagering spend, and/or frequency of visits factor into the threshold amount above expected that triggers a suspicious activity alert for an individual user. In certain embodiments, the threshold amount above expected that triggers a suspicious activity alert changes for different users over time based on an analysis of that user's historical activity. In certain such embodiments, the system employs generative artificial intelligence, such as a trained language learning model, to modify the employed threshold amount above expected for an individual user based the calculated lifetime value of that user.

In operation of certain embodiments in which the system potentially detects fraudulent behavior by an anonymous user (e.g., a user anonymous to the gaming establishment patron management system because the user is not associated with player tracking account), the system employs an assigned identifier to track one or more events and/or activities of the anonymous user and combines such tracked events and/or activities with prior tracked events and/or activities associated with that assigned identifier. The system then compares the resulting combination of actual events and/or activities that have occurred over a period of time relative to an expectation of events and/or activities that theoretically should have occurred over the period of time to detect whether or not the anonymous user is potentially engaging in nefarious behavior.

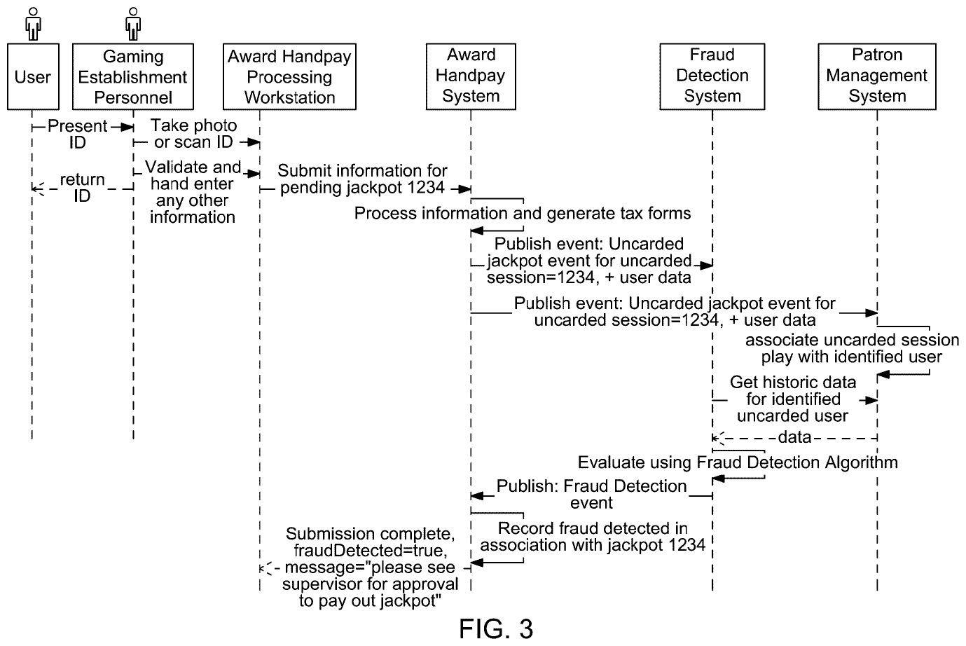

In certain embodiments, since certain users who win an award that triggers a handpay lockup event are uncarded and since during the process of gaming establishment personnel paying the award, the gaming establishment personnel are required to collect the user's identification information to properly fill in one or more jurisdictionally required tax forms, the system assigns an identifier to this information and associates historical play for the anonymous user's uncarded session with that assigned identifier. In certain such embodiments, the assigned identifier comprises the user's identification information collected by gaming establishment personnel. In certain other embodiments, the assigned identifier is independent of the user's collected identification information. As described above with respect to tracking historical play of an identified user, the system employs the assigned identifier to track the historic play of the anonymous user over time and determines, based on a comparison of actual events that occurred relative to events expected to have occurred, whether to trigger a suspicious activity alert. For example, as seen in FIG. 3 (which illustrates the described interactions between a user, a component of an award handpay system, a component of a fraud detection system and a component of a patron management system), following gaming establishment personnel collecting certain identifying information from a user (whom is anonymous to a patron management system), the component of the award handpay system notifies the component of the fraud detection system of the occurrence of the handpay lockup event (e.g., a pending jackpot). The component of the fraud detection system then operates with the component of the patron management system (which tracks events and/or activities of the identifier and not the user themselves) to obtain historic handpay lockup event data associated with the identifier. The component of the fraud detection system evaluates the actual quantity of occurrences of the handpay lockup event for the identifier relative to an expected quantity of occurrences of the handpay lockup event and determines, based on this evaluation, whether to trigger a suspicious activity alert. If so, the component of the fraud detection system notifies the component of the award handpay system which takes one or more actions to trigger an investigation into the occurrence of the handpay lockup event.

As such, in certain embodiments, responsive to a receipt of data associated with an occurrence of a designated event associated with an anonymous user at a gaming device and responsive to a receipt of data associated with an identifier assigned to the anonymous user, the system determines, based on the identifier assigned to the anonymous user, a quantity of occurrences of the designated event associated with the anonymous user relative to an expected quantity of occurrences of the designated event for the anonymous user. In these embodiments, responsive to the determination being that the quantity of occurrences of the designated event associated with the anonymous user exceeds the expected quantity of occurrences of the designated event for the anonymous user, the system triggers a suspicious activity alert.

Accordingly, in different embodiments, following a user identifying themselves to a gaming device or engaging the gaming device as an anonymous user, the system tracks one or more events and/or activities occurring at the gaming device. In these embodiments, since the determination of whether any fraud investigation is warranted is based on one or more actual events and/or activities that occurred in association with the user relative to events and/or activities expected to occur in association with the user, the system employs the tracking of such events and/or activities to make one or more determinations regarding the generation of any suspicious activity alerts.

In certain embodiments, which events and/or activities are tracked is based on one or more game play events occurring in associated with the gaming device. For example, the system tracks for the occurrence of wins associated with a value above a certain amount (e.g., wins that create a handpay lockup event as mentioned above) and/or the occurrence of winning outcomes from a certain category (e.g., royal flush wins). In other examples, the system tracks for the occurrences of a streak of outcomes (e.g., a winning streak), the triggering of a bonus game and/or the triggering of a progressive award. In these embodiments, any game play event occurring in association with one or more plays of one or more games occurring in association with one or more gaming devices may be tracked by the system to potentially be employed in the determination of a potential fraud being (or attempted to be) committed by one or more users.

In certain embodiments, which events and/or activities are tracked is based on one or more non-game play events occurring in association with the gaming device. In such embodiments, the tracked events include one or more events which occur in association with a gaming device but independent of any plays of any games of such a gaming device. In these embodiments, any non-game play event occurring in association with a gaming device may be tracked by the system to potentially be employed in the determination of a potential fraud being (or attempted to be) committed by one or more users.

It should be appreciated that any suitable event which occurs in association with a gaming device and/or any suitable quantifiable action a user takes (or does not take) in association with the gaming device may be tracked by the system of the present disclosure and employed in the determination of whether any fraud investigation is warranted. That is, data associated with any trackable input at a gaming device and/or any trackable output from the gaming device which occurs in association with one or more plays of one or more games played at the gaming device, or occurs independent of any games played at the gaming device may be tracked in accordance with the system of the present disclosure. As such, any suitable event, series of events or lack of an event may qualify as an occurrence of an event and/or activity utilized to potentially be employed in the determination of a potential fraud being (or attempted to be) committed by one or more users.

In certain embodiments, upon a triggering of a suspicious activity alert, the system undertakes one or more actions to mitigate the risk of a fraud being perpetrated. In certain such embodiments, the triggering of a suspicious activity alert results in the system alerting gaming establishment personnel to investigate the issue. In certain instances, the alert directs gaming establishment personnel to an EGM a user is currently at to investigate. In certain additional or alternative instances, the alert directs gaming establishment personnel to train security cameras on to the EGM which triggered the event.

In certain embodiments, upon an occurrence of a suspicious activity alert, the system generates an event notifying a component of a gaming establishment personnel management system that a suspicious activity alert has occurred (e.g., a player at that EGM has hit a suspicious jackpot) and gaming establishment personnel intervention is required. In other words, upon an occurrence of a requested task creation event that warrants gaming establishment personnel involvement (e.g., investigating a handpay lockup event and potentially keying off an award amount that caused an EGM to lockup awaiting a handpay by gaming establishment personnel), the system causes the creation of a task or action in association with that event. In certain such embodiments, the occurrence of a suspicious activity alert results in one or more tasks that differ based on the occurrence of the potentially fraudulent activities. For example, when a user hits a relatively large award and an EGM goes into a handpay lockup state (e.g., a W2G lockup) awaiting gaming establishment personnel to clear the handpay, the gaming establishment personnel management system previously created a task for gaming establishment personnel to go to the winning EGM and process the handpay lockup event by, if needed, collecting the user's driver's license, or other identification so that the proper tax forms can be filled in and given to the user. In certain embodiments, if a suspicious activity alert is associated with a handpay lockup event, as part of creating the task to process the handpay lockup event, the system alerts gaming establishment personnel of the occurrence of the suspicious activity alert to enable gaming establishment personnel to investigate prior to paying out any awards in associated with the handpay lockup event.

In certain embodiments, in creating one or more tasks associated with the generation of a suspicious activity alert, the system determines that certain tasks may only be processed by senior members of gaming establishment personnel and/or require approval by one or more gaming establishment personnel managers before the task can be completed (and any awards paid). In certain such embodiments, the gaming establishment personnel management system determines the appropriate gaming establishment personnel to assign the requested task. In this example, the gaming establishment personnel management system determines the appropriate gaming establishment personnel based on various factors such as: (i) gaming establishment personnel experience (e.g., is the approved task better handled by a slot technician or a player customer service representative), (ii) gaming establishment personnel status (e.g., is the player customer service representative available, busy, or soon to be available), and/or (iii) a location of the gaming establishment personnel (as determined via a location tracking technology, such as a global positioning system module of a mobile client of the gaming establishment personnel). In these embodiments, following the determination of the appropriate gaming establishment personnel to complete the approved task, the gaming establishment personnel management system notifies the gaming establishment personnel of their assigned task, such as by communicating data to a mobile client of the gaming establishment personnel to display: (i) one or more messages regarding the assigned task and any suspicious activities of the user, (ii) a location of the EGM where the tasks needs to be completed, and/or (iii) a picture of the user (such as captured by a camera of the locked-up EGM and/or a gaming establishment security camera located in proximity to the locked-up EGM).

In certain embodiments, in addition to notifying a mobile client of the gaming establishment personnel of the created task, the system causes the EGM associated with the suspicious activity alert to modify one or more output devices to enable gaming establishment personnel to more easily locate that EGM. For example, once a task is created, the system communicates data to an EGM which results in the EGM turning on/off (or blinking) one or more lights, such as a light in a candle of the EGM or displaying one or more messages via an upper display device of the EGM.

In certain embodiments, the gaming establishment personnel management system utilizes an indicator, such a visual cue or icon, of the suspicious activity alert to convey to gaming establishment personnel the existence of such a situation. In certain embodiments, in additional to or alternative from the gaming establishment personnel management system utilizing a visual indicator to convey to gaming establishment personnel the existence of such a situation, the gaming establishment personnel management system may utilize one or more non-visual indicators, such as utilizing any suitable sound, utilizing any suitable haptic feedback, to convey to gaming establishment personnel the existence (or absence) of the suspicious activity alert.

In certain embodiments, the gaming establishment personnel management system utilizes an indicator that may be accessed by gaming establishment personnel to obtain additional information regarding the suspicious activity alert. For example, a displayed indicator, such as an icon or other visual cue, may be clicked by gaming establishment personnel to display a name of the user and what events and/or activities transpired to result in the generation of the suspicious activity alert. In certain embodiments, the gaming establishment personnel management system utilizes different indicators in association with different suspicious activity alerts. For example, different events and/or activities that occurred are associated with different icons, colors, fonts, and/or sizes to convey different magnitudes of different situations of potential frauds occurring.

As such, in certain embodiments, the system tracks an activity associated with a quantity of gaming sessions. In these embodiments, responsive to a triggering of a suspicious activity alert based on a determination that the tracked activity associated with the quantity of gaming sessions does not correspond to an expected activity associated with the quantity of gaming sessions, the system communicates data that results in a display, by a display device, of an indicator associated with a workflow modification based on the suspicious activity alert.

In certain embodiments, in addition to or alternative from modifying gaming establishment personnel directives following an occurrence of the generation of a suspicious activity alert, the system restrict payouts to users and requires gaming establishment personnel to present to the user who won an award which causes the generation of the suspicious activity alert with a ticket or receipt which the user needs to redeem at a gaming establishment interface, such as a casino cage, to receive the award. Such additional processing enabled by the employment of a separate ticket or receipt enables gaming establishment personnel the opportunity to further review video from the user's gaming session as well as potentially review video from one or more periods prior to the suspicious activity alert (that is automatically collected and organized for viewing and auditing in association with the occurrence of the suspicious activity alert).

In certain embodiments, the system additionally or alternatively places one or more restrictions on the redemption of any ticket vouchers caused to be printed in association with one or more events that the system determines trigger a suspicious activity alert. In certain embodiments, once the system determines that one or more events warrant further investigation, the system then places one or more restrictions on the redemption of any ticket vouchers caused to be printed in association with such events. In certain embodiments, upon detecting that one or more ticket vouchers were printed from an event that triggers a suspicious activity alert, the system will associate (or operate with a gaming establishment ticket voucher system to associate) the ticket voucher printed or issued by the EGM as a potentially fraudulent ticket voucher. In certain embodiments, associating a ticket voucher as a potentially fraudulent ticket voucher includes changing the state of that ticket voucher such that the ticket voucher cannot be redeemed at any ticket voucher redemption points, but rather must be redeemed at one or more controlled ticket voucher redemption points of a gaming establishment. For example, the system of this embodiment causes a modification of the state of the ticket voucher to prevent redemption of that ticket voucher at a kiosk or an EGM.

In certain embodiments, the association of a ticket voucher printed or issued by an EGM as a potentially fraudulent ticket voucher additionally or alternatively includes the system modifying (or operating with a gaming establishment ticket voucher system to modify) one or more parameters of the ticket voucher by preventing non-qualified staff at a casino cage (e.g., junior casino cage staff members) from being enabled to redeem the potentially fraudulent ticket voucher. In these embodiments, the modification of the parameters of the ticket voucher result in requiring qualified staff at the casino cage (e.g., senior casino cage staff members) to approve any redemption of such a ticket voucher.

In certain embodiments, the association of a ticket voucher printed or issued by an EGM as a potentially fraudulent ticket voucher additionally or alternatively includes the system requiring gaming establishment staff to capture information associated with the person redeeming the ticket voucher to enable historic redemptions to be tracked. For example, a member of casino staff at a gaming establishment cage is required to obtain identification credentials (e.g., name, address, birthdate, physical characteristics, photo or scan of a government issued identification) of the person attempting to redeem a ticket voucher designated as a potentially fraudulent ticket voucher. In certain embodiments, the system employs this information to perform a background check on the person to determine if they have a criminal record and display such information to gaming establishment personnel to help inform them if it is safe or advised to redeem the ticket voucher for the person. In certain embodiments, the system additionally or alternatively employs the scanned identification information to track or associate historic redemptions of ticket vouchers flagged as potentially fraudulent ticket vouchers to help identify if there is a long-term pattern of people attempting to redeem such flagged ticket vouchers.

It should be appreciated that while generally described as analyzing a user's actual gaming results over one or more gaming sessions at one or more EGMs relative to theoretical gaming results expected to occur over one or more gaming sessions at such EGMs to determine if nefarious activities are potentially occurring that warrant further investigation, such analysis may occur in association with a user's online gaming activities as well. That is, the system of certain embodiments operates to analyze a user's actual gaming results over one or more gaming sessions occurring in association with one or more remote game servers operating with a personal gaming device relative to theoretical gaming results expected to occur over the one or more gaming sessions to determine if nefarious activities are potentially occurring that warrant further investigation.

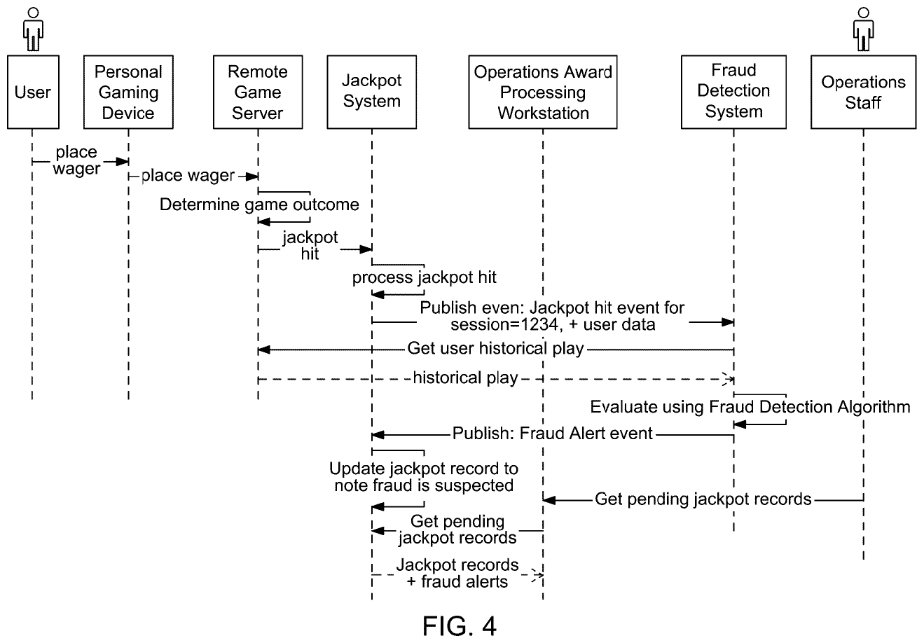

In certain embodiments, online systems that facilitate the play of games associated with an online gaming establishment (e.g., an online casino) employ a unique identifier to identify a user and employ that unique identifier over all gaming sessions started by that particular user. In these embodiments, the system employs the unique identifier to track the user's historic play as described above. By way of background, for online gaming systems, when a user wins a relatively large award, the system escrows the award for manual investigation by operations personnel. Given the current workflow pertaining to relatively large awards, the system of the present disclosure interfaces with the online gaming system to track one or more events and/or activities occurring in association with the unique identifier and combines such currently tracked events and/or activities with prior tracked events and/or activities associated with the unique identifier. The system then compares the resulting combination of actual events and/or activities that have occurred over a period of time relative to an expectation of events and/or activities that theoretically should have occurred over the period of time. In certain such embodiments, based on the comparison, the system triggers a suspicious activity alert for operations personnel to investigate prior to releasing the award from escrow. For example, as seen in FIG. 4 (which illustrates the described interactions between a user of a personal gaming device, a remote game server, a component of an award handling system, and a component of a fraud detection system), following a remote game server reporting, to the component of the award handling system, a win of a relatively large award (e.g., a pending jackpot) in association with a user tracked via an assigned identifier, the component of the award handling system notifies the component of the fraud detection system of the occurrence of the win. The component of the fraud detection system then operates with the remote game server to obtain historic data associated with the user. The component of the fraud detection system evaluates the historical data relative to expected data and determines, based on this evaluation, whether to trigger a suspicious activity alert. If so, the component of the fraud detection system notifies the component of the award handling system which takes one or more actions to trigger an investigation into the occurrence of the win.

As such, in certain embodiments, responsive to a receipt of data associated with an occurrence of a designated event determined by a remote game server operating with a personal gaming device and responsive to a receipt of data associated with an identifier of a user associated with the occurrence of the designated event, the system determines a quantity of occurrences of the designated event associated with the identifier of the user relative to an expected quantity of occurrences of the designated event for the identifier of the user. In these embodiments, responsive to the determination being that the quantity of occurrences of the designated event associated with the identifier of the user exceeds the expected quantity of occurrences of the designated event for the identifier of the user, the system triggers a suspicious activity alert in association with the occurrence of the designated event.

In certain embodiments, the online gaming system additionally or alternatively modifies how it operates by automatically releasing the award (applicable for all awards or awards up to a certain amount) from escrow if the comparison results in no suspicious activity being detected. In these embodiments, the determination of suspicious activity results in a potential fraud detection being generated and the determination of a lack of such suspicious activity results in a streamlined system that bypasses personnel involvement currently required.

Accordingly, while gaming establishment regulators and gaming establishment equipment providers have introduced various security measures to make it relatively difficult for users to commit fraudulent acts, certain malicious users working alone or in collusion with gaming establishment personnel frequently attempt to overcome these security measures with an aim of fraudulently obtaining funds from a gaming establishment, such as a physical gaming establishment or an online gaming establishment. In view of certain actions undertaken by these malicious users, the system of the present disclosure tracks certain activities associated with potential fraudulent behavior, analyzes the frequency (and/or pattern) of such tracked activities relative to an expected frequency (and/or pattern) of such activities and, if warranted, takes zero, one or more preventive actions to combat these security concerns.

It should be appreciated that any functionality or process of the present disclosure may be implemented via one or more servers, one or more gaming devices, one or more components of a gaming device (such as a component of a gaming establishment patron management system (e.g., a player tracking unit or SMIB) supported by or otherwise located inside the gaming device), one or more gaming establishment components (such as a gaming establishment patron management system, and/or a gaming establishment personnel management system), or a mobile device application (e.g. a mobile workstation of gaming establishment personnel). For example, while certain data or information of the present disclosure is explained as being communicated from a gaming device, a component associated with a gaming device, and/or a gaming establishment component to a mobile device via one or more wireless communication protocols, such data or information may additionally or alternatively be communicated from one or more servers to a mobile device via one or more wireless communication protocols. Accordingly: (i) while certain functions, features or processes are described herein as being performed by an gaming device, and/or a component associated with a gaming device, such functions, features or processes may alternatively be performed by one or more servers, or one or more mobile device applications, or one or more gaming establishment components, (ii) while certain functions, features or processes are described herein as being performed by one or more mobile device applications, such functions, features or processes may alternatively be performed by one or more servers, one or more gaming devices, one or more components of a gaming device, and/or one or more gaming establishment components, (iii) while certain functions, features or processes are described herein as being performed by one or more servers, such functions, features or processes may alternatively be performed by one or more gaming devices, one or more components of a gaming device, one or more mobile device applications, and/or one or more gaming establishment components, and (iv) while certain functions, features or processes are described herein as being performed by one or more gaming establishment components, such functions, features or processes may alternatively be performed by one or more gaming devices, one or more components of a gaming device, one or more mobile device applications, and/or one or more servers.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein refers to various configurations of: (a) one or more servers; (b) one or more electronic gaming machines such as those located on a casino floor; and/or (c) one or more personal gaming devices. Thus, in various embodiments, the system of the present disclosure includes: (a) one or more electronic gaming machines in combination with one or more servers; (b) one or more personal gaming devices in combination with one or more servers; (c) one or more personal gaming devices in combination with one or more electronic gaming machines; (d) one or more personal gaming devices, one or more electronic gaming machines, and one or more servers in combination with one another; (e) a single electronic gaming machine; (f) a plurality of electronic gaming machines in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the system includes an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, the system includes a plurality of EGMs that are each configured to communicate with a server through a data network.

In certain embodiments in which the system includes an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the system includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the system includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the system includes a server and an EGM (or personal gaming device) each located in a different gaming establishment in a same geographic area, such as a same city or a same state. Systems in which the data network is a WAN are substantially identical to systems in which the data network is a LAN, though the quantity of EGMs (or personal gaming devices) in such systems may vary relative to one another.

In further embodiments in which the system includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

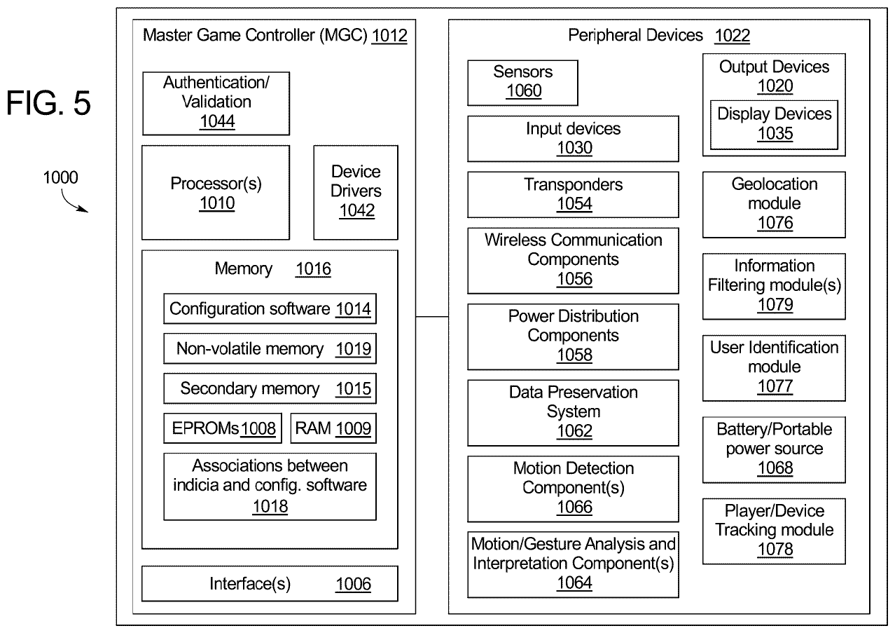

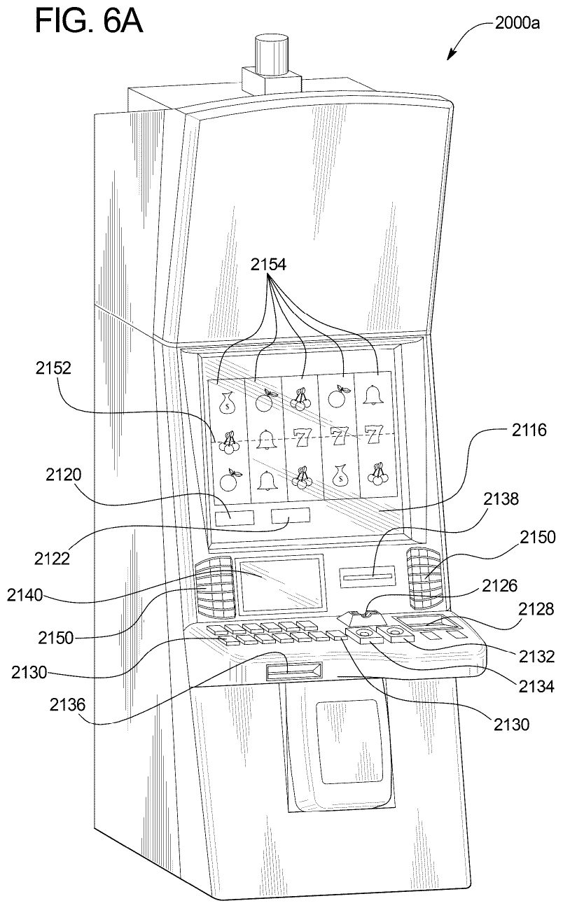

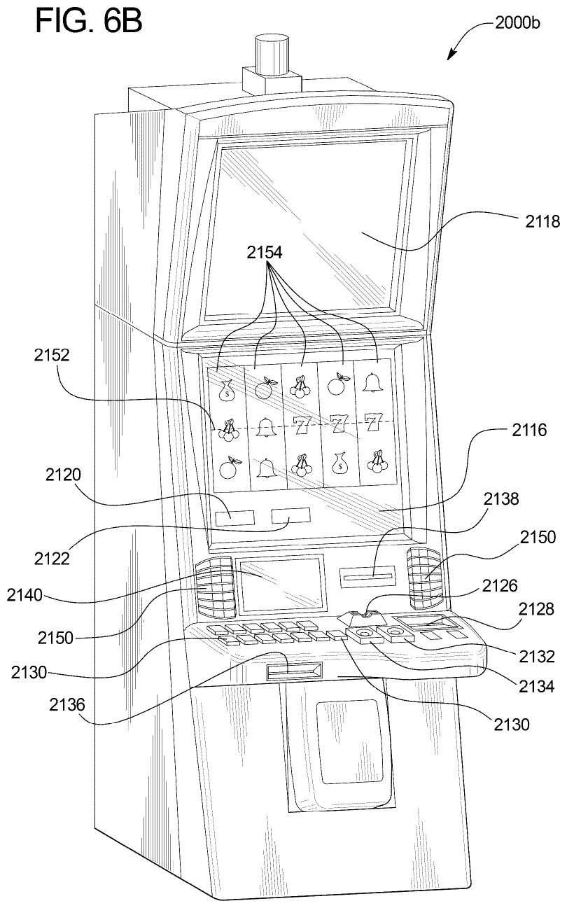

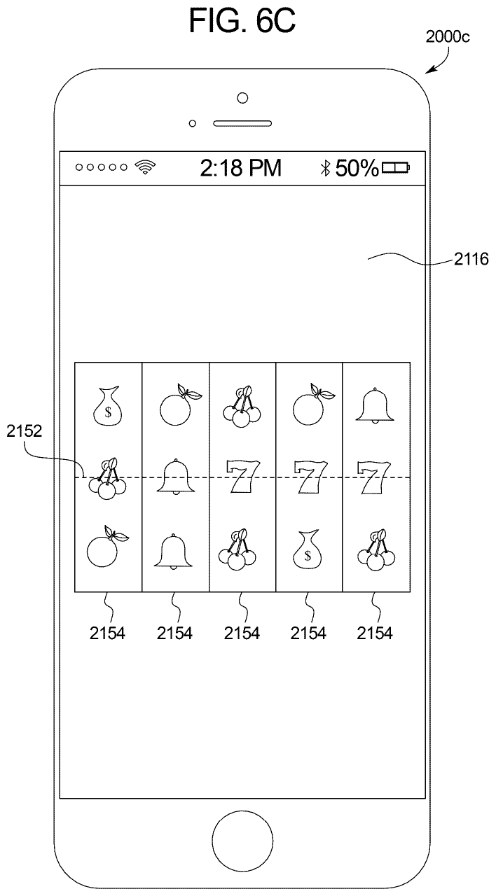

FIG. 5 is a block diagram of an example EGM 1000 and FIGS. 6A and 6B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 6C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 6A includes a central display device 2116, a player tracking display 2140, a credit display 2120, and a bet display 2122. The example EGM 2000b illustrated in FIG. 6B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 6A and 6B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 6A and 6B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 6A and 6B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 6A and 6B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 6A and 6B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 6A and 6B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 6A and 6B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 6A and 6B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 6A and 6B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all systems, and these example EGMs may not include one or more elements that are included in other systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the system includes one or more executable game programs executable by at least one processor of the system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example EGM 2000b shown in FIG. 6B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments, entries must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the system to begin a gaming session, the card reader reads the player identification number off the player tracking card to identify the player. The system timely tracks any suitable information or data relating to the identified player's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players' account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the Internet) to integrate a player's gaming experience with the player's social networking account. This enables the system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the system to receive certain information from the social network server, such as the player's likes or dislikes or the player's list of connections. In certain embodiments, the system enables the player to link the player's player account to the player's social networking account(s). This enables the system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the system enables the player to recommend a game to the player's connections by posting a recommendation to the player's wall (or other suitable area) of the social networking website.

Certain of the systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general-purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general-purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
responsive to a receipt of data associated with an occurrence of a designated event determined by a remote game server operating with a personal gaming device and responsive to a receipt of data associated with an identifier of a user associated with the occurrence of the designated event:
determine a quantity of occurrences of the designated event associated with the identifier of the user relative to an expected quantity of occurrences of the designated event for the identifier of the user, and
responsive to the determination being that the quantity of occurrences of the designated event associated with the identifier of the user exceeds the expected quantity of occurrences of the designated event for the identifier of the user, trigger a suspicious activity alert in association with the occurrence of the designated event.

2. The system of claim 1, wherein the designated event comprises an award greater than a threshold amount.

3. The system of claim 2, wherein the suspicious activity alert is associated with a delay until the award is made available to the user.

4. The system of claim 2, wherein the memory device stores a plurality of further instructions that, when executed by the processor responsive to the determination being that the quantity of occurrences of the designated event associated with the identifier of the user does not exceed the expected quantity of occurrences of the designated event for the identifier of the user, cause the processor to automatically cause the award to be made available to the user.

5. The system of claim 1, wherein the suspicious activity alert is associated with a workflow modification of an operator associated with the remote game server.

6. The system of claim 1, wherein the user comprises an identified user.

7. The system of claim 1, wherein a first occurrence of the designated event of the quantity of occurrences of the designated event associated with the identifier of the user occurred in association with a first remote game server operating with the personal gaming device and a second occurrence of the designated event of the quantity of occurrences of the designated event associated with the identifier of the user occurred in association with a second, different remote game server operating with the personal gaming device.

8. The system of claim 1, wherein a first occurrence of the designated event of the quantity of occurrences of the designated event associated with the identifier of the user occurred in association with the remote game server operating with a first personal gaming device and a second occurrence of the designated event of the quantity of occurrences of the designated event associated with the identifier of the user occurred in association with the remote game server operating with a second, different personal gaming device.

9. The system of claim 1, wherein different identifiers of different users are associated with different expected quantities of occurrences of the designated event.

10. A system comprising:
a processor; and
a memory device that stores a plurality of instructions that, when executed by the processor following an occurrence of a designated award triggering event determined by a remote game server operating with a personal gaming device, cause the processor to:
responsive to receipt of data associated with a triggering of a suspicious activity alert based on a determination that tracked activity associated with a quantity of gaming sessions does not correspond to expected activity associated with the quantity of gaming sessions, disable making the designated award available until an input associated with an investigation is received, and
responsive to no receipt of any data associated with any triggering of any suspicious activity alert, automatically make the designated award available.

11. The system of claim 10, wherein the tracked activity associated with the quantity of gaming sessions comprises tracked activity reported from multiple remote game servers.

12. A method of operating a system, the method comprising:
responsive to a receipt of data associated with an occurrence of a designated event determined by a remote game server operating with a personal gaming device and responsive to a receipt of data associated with an identifier of a user associated with the occurrence of the designated event:
determining, by a processor, a quantity of occurrences of the designated event associated with the identifier of the user relative to an expected quantity of occurrences of the designated event for the identifier of the user, and
responsive to the determination being that the quantity of occurrences of the designated event associated with the identifier of the user exceeds the expected quantity of occurrences of the designated event for the identifier of the user, triggering, by the processor, a suspicious activity alert in association with the occurrence of the designated event.

13. The method of claim 12, wherein the designated event comprises an award greater than a threshold amount.

14. The method of claim 13, wherein the suspicious activity alert is associated with a delay until the award is made available to the user.

15. The method of claim 13, further comprising, responsive to the determination being that the quantity of occurrences of the designated event associated with the identifier of the user does not exceed the expected quantity of occurrences of the designated event for the identifier of the user, automatically causing the award to be made available to the user.

16. The method of claim 12, wherein the suspicious activity alert is associated with a workflow modification of an operator associated with the remote game server.

17. The method of claim 12, wherein the user comprises an identified user.

18. The method of claim 12, wherein a first occurrence of the designated event of the quantity of occurrences of the designated event associated with the identifier of the user occurred in association with a first remote game server operating with the personal gaming device and a second occurrence of the designated event of the quantity of occurrences of the designated event associated with the identifier of the user occurred in association with a second, different remote game server operating with the personal gaming device.

19. The method of claim 12, wherein a first occurrence of the designated event of the quantity of occurrences of the designated event associated with the identifier of the user occurred in association with the remote game server operating with a first personal gaming device and a second occurrence of the designated event of the quantity of occurrences of the designated event associated with the identifier of the user occurred in association with the remote game server operating with a second, different personal gaming device.

20. The method of claim 12, wherein different identifiers of different users are associated with different expected quantities of occurrences of the designated event.
